(19) United States
(12) Patent Application Publication
(10) Pub. No.: US 2014/0047976 A1
(43) Pub. Date: Feb. 20, 2014

(54) Cardo-Polybenzoxazole Polymer/Copolymer Membranes For Improved Permeability And Method For Fabricating The Same

(71) Applicants: Yin Fong Yeong, Lahat (MY); Huan Wang, Singapore (SG); Tai-shung Neal Chung, Singapore (SG)

(72) Inventors: Yin Fong Yeong, Lahat (MY); Huan Wang, Singapore (SG); Tai-shung Neal Chung, Singapore (SG)

(21) Appl. No.: 14/113,124

(22) PCT Filed: Apr. 27, 2012
(86) PCT No.: PCT/SG12/00153

§ 371 Date: Oct. 21, 2013

Related U.S. Application Data
(60) Provisional application No. 61/480,446, filed on Apr. 29, 2011.

(51) Int. Cl. B01D 71/64; B01D 53/22

(52) U.S. Cl. CPC B01D 71/64; B01D 53/228
USPC 95/45; 528/170; 96/10; 264/216

(57) ABSTRACT

The present invention discloses a series of cardo-polybenzoxazole copolymer membranes, methods for preparing the cardo-polybenzoxazole copolymer membrane from thermal rearrangement of cardo-copolyimide membranes, and methods of methods for the separation of a fluid from a mixture of fluids by utilizing the cardo-polybenzoxazole copolymer membrane.

### RELATED APPLICATION

This application claims the benefit of U.S. Provisional Application No. 61/480,446, filed on Apr. 29, 2011. The entire teachings of the above application are incorporated herein by reference.

### BACKGROUND OF THE INVENTION

Membrane-based technology has emerged as an economical and highly energy-efficient alternative to conventional technology in separation applications. Polymeric membranes, in particular, are advantageous due to their low cost, good permeability, mechanical stability, ease of fabrication, and scalability of the fabrication process [1-3]. The molecular structure of the polymeric membrane correlates to the permeability and permselectivity of the membrane [4-5]. Separation of gaseous mixtures operates through a solution-diffusion mechanism, and the efficiency of such a process necessitates both a high permeability coefficient as well as a high level of selectivity for one component of the gaseous mixture. Generally speaking, however, there is a well-documented “trade-off” relationship between permeability and selectivity: Changes to the molecular structure of a polymer membrane that increase permeability also cause losses in permselectivity [6].

Polyimide (PI) polymer membranes have been applied to gas separation processes with limited success. Polyimides are composed of rigid main chains with strong intermolecular interactions, which results in small polymer size, and low fractional free volume [7-8].

Polybenzoxazole (PBO) polymer membranes have been investigated in separation applications as well [9-12]. These membranes, which may be generated via a thermal rearrangement of PI membranes [12], exhibit excellent thermal and chemical stability as well as enhanced permselectivity. However, the rigid ring units of PBO enable efficient packing of the polymer, which results in lower fractional free volume, and therefore lower gas permeability through a polybenzoxazole membrane. Current challenges exist in determining structural modifications that would enhance the gas separation performance of the polymer.

Introduction of a sterically bulky cyclic moiety into the polyimide backbone has been implemented as an effective approach to improve the gas permeation performance of polyimide membranes. The presence of these bulky or “cardo” groups (so-called due to the Latin term for “loop”) hinders molecular packing and reduces the rotational mobility of the main chain, increasing the fractional free volume, and therefore the permeability of the membrane. In particular, implementation of a stiff and large fluorenyl cardo-group, which consists of four phenyl rings connected to a quaternary carbon center, has been used to effectively improve gas permeation properties of the polyimide membrane [13-15].

Due to the limitations associated with permeability and permselectivity of previously reported polymer membranes, it is desirable to design a superior polymer membrane, having in its structure a cardo group to increase its fractional free volume, which would improve upon the efficiency of other membrane-based methods for fluid separation.

### SUMMARY OF THE INVENTION

In one embodiment of the invention, a cardo-polybenzoxazole copolymer is disclosed having the structure of formula (I):

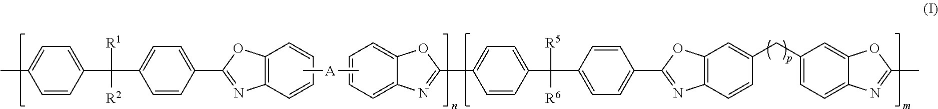

wherein: m is an integer from 0 to 100;
n is an integer from 0 to 100;
and the sum of m and n is 100;
p is an integer from 0 to 1;
R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group; and
R⁵ and R⁶ are independently (C₁-C₆)alkyl or (C₁-C₆)haloalkyl.

In one embodiment of the invention, when A has the formula CR³R⁴, R³ and R⁴ are taken together to form a ring structure of formula (II):

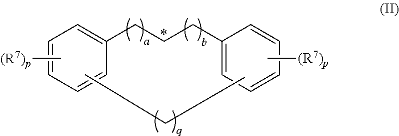

Wherein: a and b are each integers independently selected from zero to 5 and the sum of a and b is less than or equal to 10;
q is an integer from zero to 1;
each R⁷ is independently selected from H, (C₁-C₆)alkyl, (C₆-C₂₄)aryl, or heteroaryl;
p is an integer from 1 to 4;
and the asterisk (*) indicates the point of attachment to the carbon of CR³R⁴.

In another embodiment, the cardo-polybenzoxazole copolymer of the present invention comprises units of both cardo-polybenzoxazole and polybenzoxazole.
In a preferred embodiment, the cardo-polybenzoxazole copolymer comprises repeating units of formula (III):

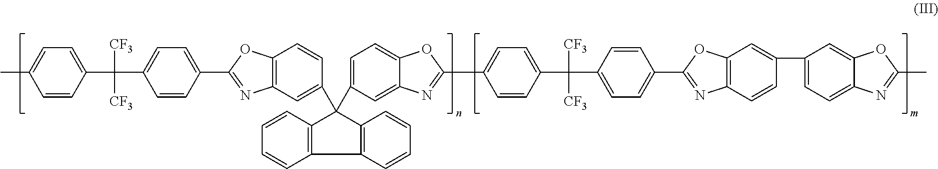

wherein: m is an integer from 0 to 100;
n is an integer from 0 to 100;
and the sum of m and n is 100.

The cardo-polybenzoxazole copolymer of the invention is in the form of a membrane having a geometry comprising flat sheet, hollow fiber, tube, thin film composite, or disk.

Also described herein are methods for producing the cardo-polybenzoxazole copolymer membranes from precursor cardo-copolyimide membranes. In one aspect, the process of forming a cardo-polybenzoxazole copolymer membrane comprises a) synthesizing a cardo-copolyimide material by polycondensation of a diphthalic anhydride with a mixture of diamine and cardo-diamine; b) casting a solution of the cardo-copolyimide into a membrane; and c) exposing the membrane of step b) to a temperature and pressure that will bring about a thermal rearrangement of the cardo-copolyimide membrane to form a cardo-polybenzoxazole copolymer membrane. Furthermore, the cardo-polybenzoxazole membranes of the invention can be fabricated into geometries including, but not limited to, flat sheet, hollow fiber, tube, thin film, and disk.

The present invention also discloses a method for the separation of a fluid from a mixture of fluids. In one aspect, the process for separating at least one fluid from a mixture of fluids comprises: a) providing a cardo-polybenzoxazole copolymer membrane; and b) bringing a mixture of fluids under pressure into contact with the membrane of step a), whereby one of the at least one fluids permeates the membrane preferentially with respect to at least one other fluid in the mixture of fluids, thereby separating the fluid from the mixture. The membranes of the present invention are useful for a variety of separation processes including, but not limited to, the separation of mixtures of gases, liquids, vapors, aqueous solutions, hydrocarbon isomers, olefins/paraffins, iso/normal paraffins, proteins, as well as recovery and purification of biofuel from acetone-butanol-ethanol (ABE) fermentation (e.g. pervaporation), adsorption, deep sulfurization of gasoline and diesel fuel, desalination of water, and forward osmosis processes.

The cardo-polybenzoxazole copolymers or the invention are fabricated from a thermal rearrangement of copolyimide materials. The membranes exhibit high thermal and mechanical stability, may adopt a variety of geometries, and also demonstrate enhanced gas permeability and permselectivity as compared to polybenzoxazole membranes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows ATR-RT-IR spectra of membranes obtained in Example 2 and Example 3.

FIG. 2 shows ATR-RT-IR spectra of membranes obtained in Example 5 and Example 6.

FIG. 3 shows ATR-RT-IR spectra of membranes obtained in Example 8 and Example 9 (m=90, n=10).

FIG. 4 shows TGA curves of membranes obtained in Example 2 and Example 3.

FIG. 5 shows TGA curves of membranes obtained in Example 5 and Example 6.

FIG. 6 shows TGA curves of membranes obtained in Example 8 and Example 9 (m=90, n=10).

FIG. 7 shows a graph comparing oxygen permeability (Barrer) and oxygen/nitrogen selectivity for membranes prepared in Example 3, Example 6, and Example 9.

FIG. 8 shows a graph comparing hydrogen permeability (Barrer) and hydrogen/methane selectivity for membranes prepared in Example 3, Example 6, and Example 9.

FIG. 9 shows a graph comparing carbon dioxide permeability (Barrer) and carbon dioxide/methane selectivity for membranes prepared in Example 3, Example 6, and Example 9.

### DETAILED DESCRIPTION OF THE INVENTION

A description of example embodiments of the invention follows.

In this invention, novel cardo-polybenzoxazole (CPBO) copolymer membranes have been prepared from a thermal rearrangement of cardo-polyimide (CPI) copolymer membranes. The CPI copolymer membranes are prepared by reacting various compositions of diamine and cardo-diamine starting materials with a substituted diphthalic anhydride, and subsequently casting the resultant material into a membrane. The cardo-polybenzoxazole copolymer membranes of the invention demonstrate good thermal and mechanical stability, and are fabricated into geometries comprising flat sheet, hollow fiber, tube, thin film, and disk. Permeation tests reveal that these membranes are useful for a variety of separation processes, including, but not limited to, the separation of mixtures of gases, liquids, vapors, aqueous solutions, hydrocarbon isomers, olefins/paraffins, iso/normal paraffins, proteins, as well as recovery and purification of biofuel from acetone-butanol-ethanol (ABE) fermentation (e.g. pervaporation), adsorption, deep sulfurization of gasoline and diesel fuel, desalination of water, and forward osmosis processes. In particular, gases that are suitable for use with the invention include, but are not limited to, H₂, O₂, N₂, CH₄, and CO₂. Furthermore, this invention is suitable for the separation of mixtures of gases including, but not limited to, CO₂/N₂, CO₂/CH₄, O₂/N₂, and H₂/CH₄.

Many research efforts have focused on the development of polymeric materials capable of superior performance in fluid separation technology due to industrial demand. While not wishing to be bound by theory, it is believed certain structural modifications of the polymer backbone may be able to overcome the “trade-off” relationship that exists between permeability and selectivity [6]. In particular, structural changes that hinder packing of the main chain increase permeability, by increasing the fractional free volume. Improved permselectivity, without a loss of permeability, is achieved by reducing the rotational mobility around the flexible linkage in the polymer chain [14]. Introduction of a sterically bulky or “cardo” group effectively hinders packing and restricts rotational mobility, resulting in improvements in both permeability and selectivity.

The novel cardo-polybenzoxazole copolymer (CPBOc) membranes of the invention are generated from a thermal rearrangement of cardo-copolyimide (CcPI) membranes. CcPI membranes are cast into a desired geometry from a solution of CcPI in solvent. The synthesis of the cardo-copolyimide polymer, as well as the polyimide polymer, and the cardopolyimide polymer, is as follows.

### Synthesis of Polyimide (PI)

As depicted in Scheme 1, polyimide (PI) was synthesized by polycondensation of a diphthalic anhydride with the formula:

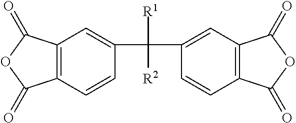

wherein: R¹ and R² are independently (C₁-C₆)alkyl or (C₁-C₆)haloalkyl;
with a hydroxyl-containing diamine of the formula:

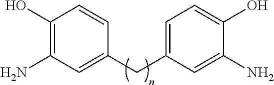

Wherein: n is an integer ranging from 0 to 1;
in an organic solvent.

In one embodiment of the invention, the diphthalic anhydride can be 3,3′,4,4′-biphenyltetracarboxylic dianhydride, 4,4′-oxydiphthalic anhydride, benzophenone-3,3′,4,4′-tetracarboxylic dianhydride, pyromellitic dianhydride, 1,4,5,8-naphthalenetetracarboxylic dianhydride, ethylenediaminetetraacetic dianhydride, cyclobutane-1,2,3,4-tetracarboxylic dianhydride, or perylene-3,4,9,10-tetracarboxylic dianhydride, or any other aromatic anhydride known to one of skill in the art, and in a preferred embodiment, the diphthalic anhyridide is 4,4′-hexafluoroisopropylidenediphthalic anhydride (6FDA). In one embodiment of the invention, the hydroxyl-containing diamine can be 2,5-diaminophenol, 2,4-diaminophenol, or 4,4′-methylenebis(2-aminophenol), and in a preferred embodiment of the invention, PI is synthesized with diamine 3,3′-dihydroxybenzidine (HAB). The synthesis of the PI membranes is carried out in an organic solvent. In one aspect of the invention, the solvent is tetrahydrofuran, acetone, dimethylsulfoxide, cyclohexanone, or cyclopentanone. In another aspect of the invention, the solvent is an amide solvent, selected from a list comprising N,N-dimethylacetamide (DMA), N,N-dimethylformamide (DMF), N-methylformamide (NMF), formamide, N-Methyl-2-pyrrolidinone (NMP), or 2-pyrrolidinone. In a preferred embodiment, the solvent used in the synthesis of PI is N-Methyl-2-pyrrolidinone (NMP).

### Synthesis of Cardo-polyimide (CPI)

As depicted in Scheme 1, cardo-polyimide (CPI) was synthesized by polycondensation of a diphthalic anhydride with the formula:

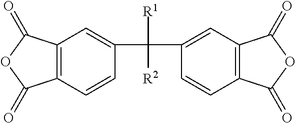

Wherein: R¹ and R² are independently (C₁-C₆)alkyl or (C₁-C₆)haloalkyl;
with a hydroxyl-containing cardo-diamine of the formula:

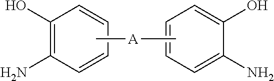

wherein: A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group as shown in formula (II);
in an organic solvent.

In one aspect of the invention, the diphthalic anhydride can be 3,3′,4,4′-biphenyltetracarboxylic dianhydride, 4,4′-oxydiphthalic anhydride, benzophenone-3,3′,4,4′-tetracarboxylic dianhydride pyromellitic dianhydride, 1,4,5,8-naphthalenetetracarboxylic dianhydride, ethylenediaminetetraacetic dianhydride, cyclobutane-1,2,3,4-tetracarboxylic dianhydride, or perylene-3,4,9,10-tetracarboxylic dianhydride, or any other aromatic anhydride known to one of skill in the art, and in a preferred embodiment, the diphthalic anhyridide is 4,4′-hexafluoroisopropylidenediphthalic anhydride (6FDA).

When A is a methylene linker, in one embodiment of the invention, R³ and R⁴ in the hydroxyl-containing cardo-diamine are each CF₃. In a preferred embodiment of the invention, R³ and R⁴ in the hydroxyl-containing cardo-diamine are taken together to form a cardo group selected from the list comprising phenalene, acenaphthene, benzo[a]fluorene, and fluorene.

When A is not present, the aminophenol groups are fused to form a 2-ring bis(amino)bisphenol system comprising 3,6-diaminonaphthalene-2,7-diol. When A is present as a polycyclic aromatic hydrocarbon, it is taken together with the aminophenol groups to form a 3-ring bis(amino)bisphenol system, a 4-ring bis(amino)bisphenol system, a 5-ring bis(amino)bisphenol system, or a larger multi-ring bis(amino)bisphenol system. For example, the hydroxyl-containing cardo-diamine is selected from but not limited to diamino-polycyclic aromatic hydrocarbon diols comprising 3,6-diaminoanthracene-2,7-diol, 1,8-diaminophenanthrene-2,7-diol, 2,7-diaminophenanthrene-3,6-diol, 3,6-diaminophenanthrene-2,7-diol, 3,8-diaminotetracene-2,9-diol, 1,8-diaminopyrene-2,7-diol, 3,6-diaminotriphenylene-2,7-diol, 1,8-diaminotriphenylene-2,7-diol, 3,8-diaminochrysene-2,9-diol, 3,10-diaminobenzo[c]phenanthrene-4,9-diol, 2,5-diaminoperylene-1,6-diol, 3,9-aminopentacene-2,10-diol, or any other diamino-polycyclic aromatic hydrocarbon diol known to one of skill in the art that is capable of forming a polybenzoxazole structure, and the constitutional isomers thereof. “Constitutional isomers” as used herein are molecules of the same molecular formula that differ in the connectivity of atoms.

In a more preferred embodiment of the invention, CPI is synthesized with cardo-diamine 9,9-bis(3-amino-4-hydroxyphenyl)fluorene (BisAHPF). The synthesis of the CPI membranes is carried out in an organic solvent. In one aspect of the invention, the solvent is tetrahydrofuran, acetone, dimethylsulfoxide, cyclohexanone, or cyclopentanone. In another aspect of the invention, the solvent is an amide solvent, selected from a list comprising N,N-dimethylacetamide (DMA), N,N-dimethylformamide (DMF), N-methylformamide (NMF), formamide, N-Methyl-2-pyrrolidinone (NMP), or 2-pyrrolidinone. In a preferred embodiment, the solvent used in the synthesis of CPI is N-Methyl-2-pyrrolidinone (NMP).

A process for producing PI and CPI polymers for use in the present invention is given in Scheme 1:

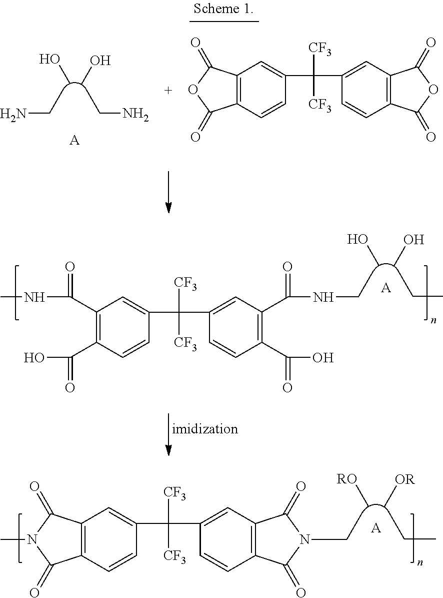

Where, for the synthesis of PI, a preferred embodiment of A is:

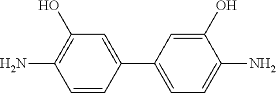 [SMILES: Nc1ccc(-c2ccc(N)c(O)c2)cc1O]

And where, for the synthesis of CPI, a preferred embodiment of A is:

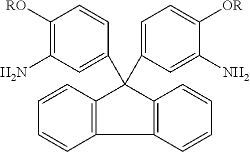

Substituent R is H for a thermally imidized polymer, or —C(CH₃)O for a chemically imidized polymer [9];
and n is an integer from 0 to 100.

### Synthesis of Cardo-copolyimide (CcPI)

Cardo-copolyimides (CcPI) were synthesized by polycondensation of a diphthalic anhydride with the formula:

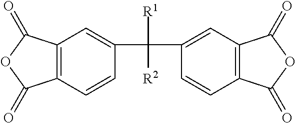

wherein: R¹ and R² are independently (C₁-C₆)alkyl or (C₁-C₆)haloalkyl;
with a mixture of hydroxyl-containing diamine of the formula:

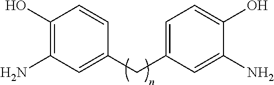

wherein: n is an integer ranging from zero to 1;
and
a hydroxyl-containing cardo-diamine of the formula:

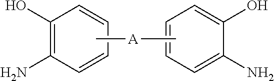

wherein: A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group;
in an organic solvent.

In one aspect of the invention, the ratio of hydroxyl-containing diamine to hydroxyl-containing cardo-diamine in the mixture is in the range of 99:1 up to 1:99 hydroxyl-containing diamine to hydroxyl-containing cardo-diamine. In a preferred embodiment of the invention, the ratio of hydroxyl-containing diamine to hydroxyl-containing cardo-diamine in the mixture includes, but is not limited to 95:5, 90:10, 85:15, 80:20, 70:30, 50:50, and 30:70. In a more preferred embodiment of the invention, the ratio of hydroxyl-containing diamine to hydroxyl-containing cardo-diamine in the mixture to generate the CcPI polymer is 90:10. In one embodiment of the invention, the diphthalic anhydride can be 3,3′,4,4′-biphenyltetracarboxylic dianhydride, 4,4′-oxydiphthalic anhydride, benzophenone-3,3′,4,4′-tetracarboxylic dianhydride pyromellitic dianhydride, 1,4,5,8-naphthalenetetracarboxylic dianhydride, ethylenediaminetetraacetic dianhydride, cyclobutane-1,2,3,4-tetracarboxylic dianhydride, or perylene-3,4,9,10-tetracarboxylic dianhydride, or any other aromatic anhydride known to one of skill in the art, and in a preferred embodiment, the diphthalic anhyridide is 4,4′-hexafluoroisopropylidenediphthalic anhydride (6FDA). In one embodiment of the invention, the hydroxyl-containing diamine can be 2,5-diaminophenol, 2,4-diaminophenol, or 4,4′-methylenebis(2-aminophenol), and in a preferred embodiment of the invention, CcPI is synthesized with diamine 3,3′-dihydroxybenzidine (HAB).

When A is a methylene linker, in one embodiment of the invention, R³ and R⁴ in the hydroxyl-containing cardo-diamine are each CF₃. In a preferred embodiment of the invention, R³ and R⁴ in the hydroxyl-containing cardo-diamine are taken together to form a cardo group selected from the list comprising phenalene, acenaphthene, benzo[a]fluorene, and fluorene.

When A is not present, the aminophenol groups are fused to form a 2-ring bis(amino)bisphenol system comprising 3,6-diaminonaphthalene-2,7-diol. When A is present as a polycyclic aromatic hydrocarbon, it is taken together with the aminophenol groups to form a 3-ring bis(amino)bisphenol system, a 4-ring bis(amino)bisphenol system, a 5-ring bis(amino)bisphenol system, or a larger multi-ring bis(amino)bisphenol system. For example, the hydroxyl-containing cardo-diamine is selected from but not limited to diamino-polycyclic aromatic hydrocarbon diols comprising 3,6-diaminoanthracene-2,7-diol, 1,8-diaminophenanthrene-2,7-diol, 2,7-diaminophenanthrene-3,6-diol, 3,6-diaminophenanthrene-2,7-diol, 3,8-diaminotetracene-2,9-diol, 1,8-diaminopyrene-2,7-diol, 3,6-diaminotriphenylene-2,7-diol, 1,8-diaminotriphenylene-2,7-diol, 3,8-diaminochrysene-2,9-diol, 3,10-diaminobenzo[c]phenanthrene-4,9-diol, 2,5-diaminoperylene-1,6-diol, 3,9-aminopentacene-2,10-diol, or any other diamino-polycyclic aromatic hydrocarbon diol known to one of skill in the art that is capable of forming a polybenzoxazole structure, and the constitutional isomers thereof. “Constitutional isomers” as used herein are molecules of the same molecular formula that differ in the connectivity of atoms.

In a more preferred embodiment of the invention, CcPI is synthesized with cardo-diamine 9,9-bis(3-amino-4-hydroxyphenyl)fluorene (BisAHPF). The synthesis of the CcPI membranes is carried out in an organic solvent. In one aspect of the invention, the solvent is tetrahydrofuran, acetone, dimethylsulfoxide, cyclohexanone, or cyclopentanone. In another aspect of the invention, the solvent is an amide solvent, selected from a list comprising N,N-dimethylacetamide (DMA), N,N-dimethylformamide (DMF), N-methylformamide (NMF), formamide, N-Methyl-2-pyrrolidinone (NMP), or 2-pyrrolidinone. In a preferred embodiment, the solvent used in the synthesis of CcPI is N-Methyl-2-pyrrolidinone (NMP). A process for producing CcPI polymers for use in the present invention is given in Scheme 2:

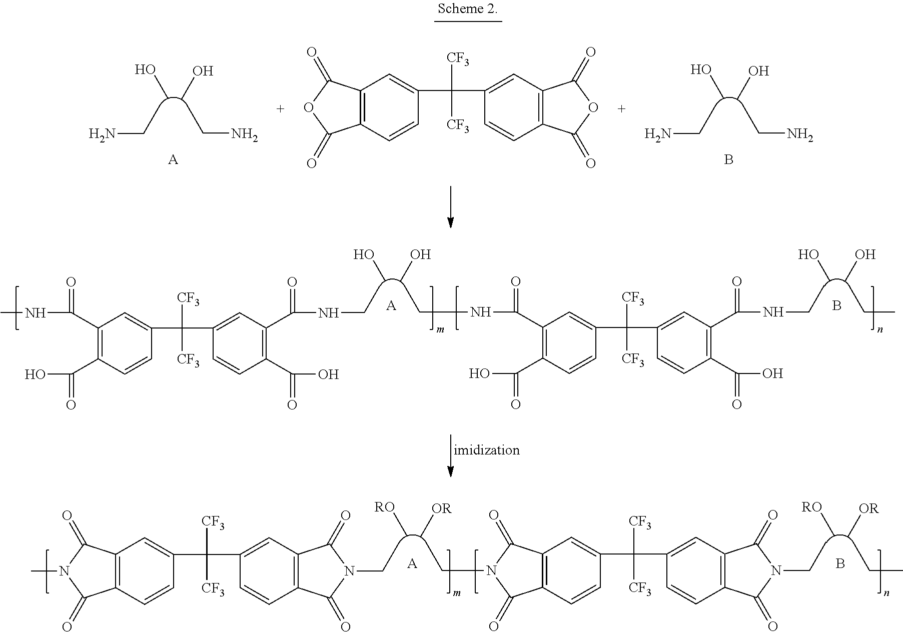

Where, in the synthesis of CcPI, a preferred embodiment of A is:

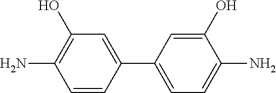 [SMILES: Nc1ccc(-c2ccc(N)c(O)c2)cc1O]

And a preferred embodiment of B is:

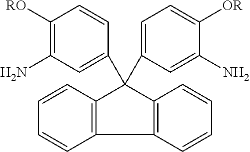

Substituent R is H for a thermally imidized polymer, or —C(CH₃)O for a chemically imidized polymer [9];
m and n are each integers ranging from 0 to 100, wherein the sum of m and n is 100.

In one embodiment of the invention, m and n are integers from 5 to 95, wherein the sum of m and n is 100, and in a preferred embodiment of the invention, m and n are integers from 10 to 90, wherein the sum of m and n is 100.

The cardo-copolyimides of the invention are random copolymers.

### Membrane Preparation

The polyimide (PI), cardopolyimide (CPI), and cardo-copolyimide (CcPI) membranes of the invention are made by a process that comprises a) preparing a solution of PI, CPI, or CcPI in solvent, b) fabricating the solution to produce a membrane, and c) drying the membrane. The membranes of PI, CPI, or CcPI can be fabricated into flat sheet, hollow fiber, tube, thin film, and disk geometries.

The PI, CPI, and CcPI membranes of the invention are manufactured by the methods described below, which are not intended to be limiting in any way. The solution of PI, CPI, or CcPI is created in an organic solvent capable of fully solvating the polymer. In a preferred embodiment of the invention, the concentration of the solution is from about 15 wt % to about 25 wt %. In one aspect of the invention, the solvent is selected from a group comprising acetone, tetrahydrofuran, dimethyl sulfoxide, cyclohexanone, and cyclopentanone. In another embodiment, the solvent used is an amide solvent such as N,N-dimethylacetamide (DMA), N,N-dimethylformamide (DMF), N-methylformamide (NMF), formamide, N-Methyl-2-pyrrolidinone (NMP), or 2-pyrrolidinone. In a preferred embodiment, the solvent used to create a solution of PI, CPI, or CcPI is N,N-dimethylformamide (DMF).

The PI, CPI, or CcPI solution can be cast onto a form having a desired shape or configuration depending upon the intended end use. In an example embodiment, the flat sheet is created by first casting the homogeneous solution described in step a) onto a substrate, mold, or form. The substrate, mold, or form is then placed in an oven and dried overnight at a temperature of about 80° C. to evaporate the latent solvent. The pristine PI, CPI, or CcPI membranes are then detached from the substrate, mold, or form and placed into the vacuum oven for complete solvent evaporation by heating from about 75° C. to about 200° C. with a temperature ramping rate of about 25° C./h.

In another example, the solution is cast in the form of hollow fibers. The hollow fibers can be fabricated by a non-solvent induced phase inversion method. For dual layer hollow fiber spinning, the inner layer dope and outer layer dope are co-extruded together through a triple-orifice spinneret by a dry-jet/wet spinning process. The detailed description of the set up for dual-layer hollow fiber spinning and process can be found elsewhere [16].

The polybenzoxazole (PBO), cardopolybenzoxazole (CPBO), and cardopolybenzoxazole copolymer (CPBOc) membranes of the invention are made by a process that comprises a) providing PI, CPI, or CcPI membranes as described above, and b) subjecting the membranes to thermal treatment at elevated temperature and atmospheric or sub-atmospheric pressure.

The PBO, CPBO, and CPBOc membranes are manufactured by the methods described below, which are not intended to be limiting in any way. The PI, CPI, or CcPI membranes are subjected to temperature conditions capable of bringing about a thermal rearrangement, in which the array of atoms in the polyimide changes to form a polybenzoxazole. In an example embodiment, the membranes are subjected to thermal treatment at a temperature in the range or about 350° C. to about 450° C. for about 30 minutes to about 60 minutes. In a preferred embodiment, the pristine PI, CPI, or CcPI membranes are subjected to thermal treatment at about 425° C. for about 30 minutes under vacuum in a preheated furnace. The membrane is removed from the furnace after the thermal treatment and stored in a desiccator before use.

### Thermal Rearrangement of PI to PBO

Polybenzoxazole (PBO) membrane is created by a thermal rearrangement of PI membrane, in which the array of atoms in PI changes to form PBO. This process is depicted below:

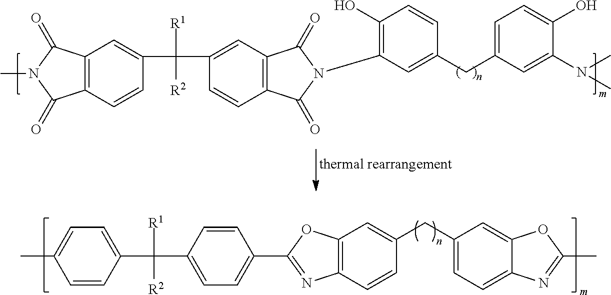

wherein: R¹ and R² are independently (C₁-C₆)alkyl or (C₁-C₆)haloalkyl;
n is an integer ranging from 0 to 1; and
m is an integer from 0 to 100.

In another embodiment of the invention, CR¹R² can be deleted, or replaced by oxygen. In a preferred embodiment of the invention, R¹ and R² are each CF₃. In a preferred embodiment of the invention, n is zero.

### Thermal Rearrangement of CPI to CPBO

Cardopolybenzoxazole (CPBO) membrane is made by a thermal rearrangement of CPI membrane, in which the array of atoms in CPI changes to form CPBO as depicted below:

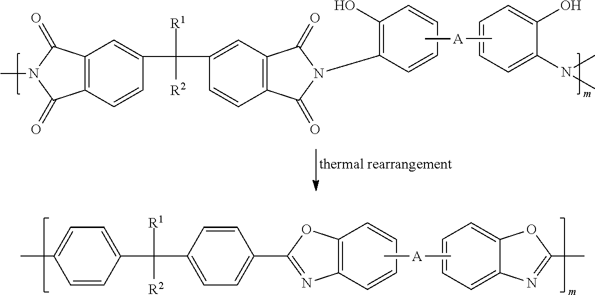

wherein: R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group; and
m is an integer from 0 to 100.

In another embodiment of the invention, CR¹R² can be deleted, or replaced by oxygen. In a preferred embodiment of the invention, R¹ and R² are each CF₃. When A is a methylene linker, in one embodiment of the invention, R³ and R⁴ in the hydroxyl-containing cardo-diamine are each CF₃. In a preferred embodiment of the invention, R³ and R⁴ in the hydroxyl-containing cardo-diamine are taken together to form a cardo group selected from the list comprising phenalene, acenaphthene, benzo[a]fluorene, and fluorene. In a more preferred embodiment of the invention, R³ and R⁴ are taken together to be a fluorenyl group.

When A is not present, the bis(polybenzoxazole) ring system is fused to 2-ring polybenzoxazole system. The ring-count for the bis(amino)bisphenol reactants is adhered to in assigning the ring-count for the polybenzoxazole system. For example, when A is not present, the ring system is fused to form a polybenzoxazole with a naphthalene hydrocarbon core, as shown in an example embodiment, below.

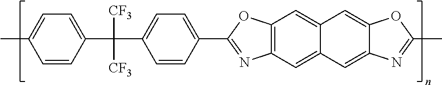

When A is present as a polycyclic aromatic hydrocarbon, it is taken together with the polybenzoxazole groups to form a 3-ring polybenzoxazole system, a 4-ring polybenzoxazole system, a 5-ring polybenzoxazole system, or a larger multi-ring polybenzoxazole system. For example, the aromatic hydrocarbon core of the diamino-polycyclic aromatic hydrocarbon diol is selected from a list of polycyclic aromatic hydrocarbons comprising anthracene, phenanthrene, tetracene, pyrene, triphenylene, chrysene, benzo[c]phenanthrene, perylene, and pentacene, or any other polycyclic aromatic hydrocarbon known to one of skill in the art.

Example embodiments of the cardopolybenzoxazole polymer when A is present as a polycyclic aromatic hydrocarbon are shown below:

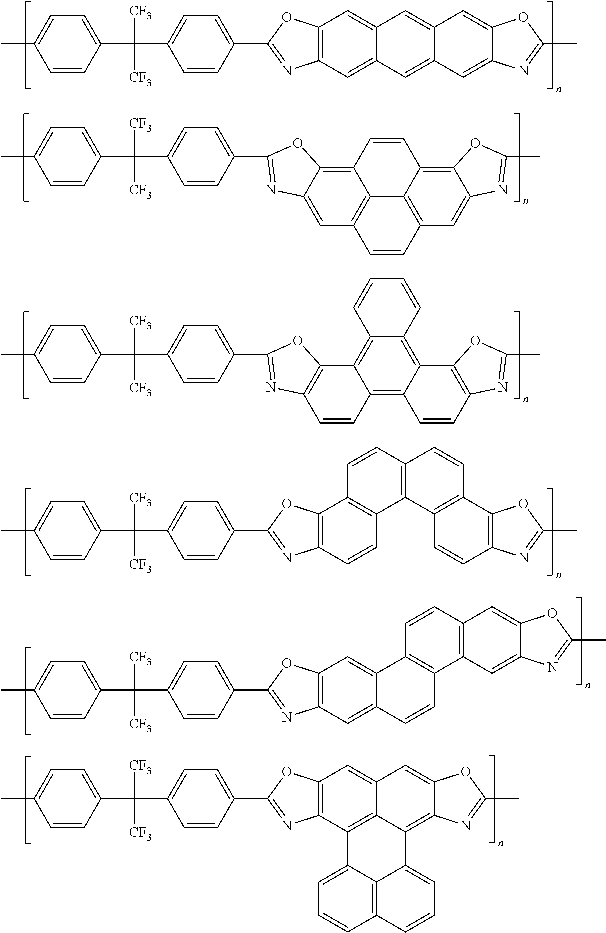

A schematic depicting the thermal rearrangement of polyimide (PI) and cardopolyimide (CPI) to polybenzoxazole (PBO) and cardo-polybenzoxazole (CPBO) in a preferred embodiment is shown in Scheme 3:

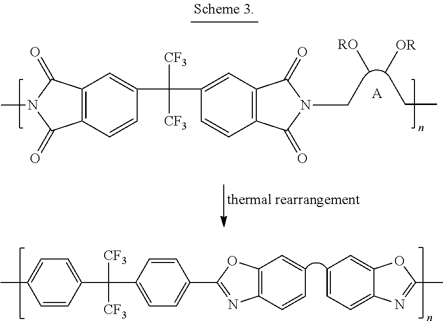

Where, for obtaining PBO, a preferred embodiment of A is:

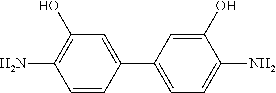 [SMILES: Nc1ccc(-c2ccc(N)c(O)c2)cc1O]

and, for obtaining CPBO, a preferred embodiment of A is:

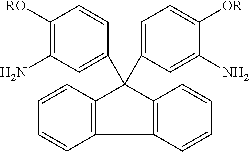

wherein: substituent R is H or —C(CH₃)O; and
n is an integer from 0 to 100.

Cardopolybenzoxazole copolymer (CPBOc) membrane is made through a thermal rearrangement of CcPI membrane, as depicted below:

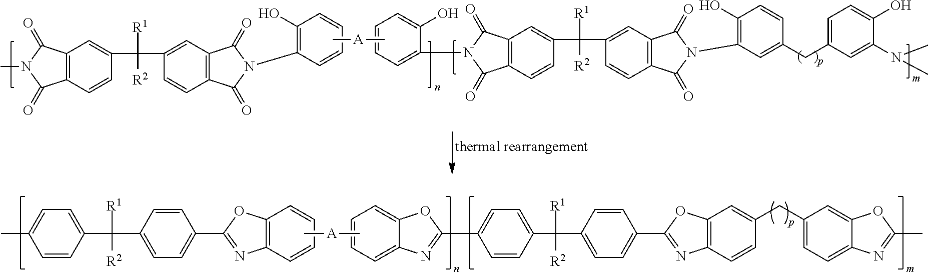

wherein: R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group;
p is an integer ranging from zero to 1;
m is an integer ranging from 0 to 100;
n is an integer from 0 to 100; and
the sum of m and n is 100.

In one embodiment of the invention, m and n are integers from 5 to 95, wherein the sum of m and n is 100, and in a preferred embodiment of the invention, m and n are integers from 10 to 90, wherein the sum of m and n is 100.

The cardo-polybenzoxazole copolymers of the invention are random copolymers.

In another embodiment of the invention, CR¹R² can be deleted, or replaced by oxygen. In a preferred embodiment of the invention, R¹ and R² are each CF₃. When A is a methylene linker, in one embodiment of the invention, R³ and R⁴ in the hydroxyl-containing cardo-diamine are each CF₃. In a preferred embodiment of the invention, R³ and R⁴ in the hydroxyl-containing cardo-diamine are taken together to form a cardo group selected from the list comprising phenalene, acenaphthene, benzo[a]fluorene, and fluorene. In a more preferred embodiment of the invention, R³ and R⁴ are taken together to be a fluorenyl group.

When A is not present, the bis(polybenzoxazole) ring system is fused to 2-ring polybenzoxazole system. The ring-count for the bis(amino)bisphenol reactants is adhered to in assigning the ring-count for the polybenzoxazole system. For example, when A is not present, the ring system is fused to form a polybenzoxazole with a naphthalene hydrocarbon core, as shown in an example embodiment, below.

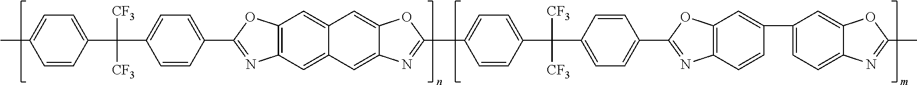

When A is present as a polycyclic aromatic hydrocarbon, it is taken together with the polybenzoxazole groups to form a 3-ring polybenzoxazole system, a 4-ring polybenzoxazole system, a 5-ring polybenzoxazole system, or a larger multi-ring polybenzoxazole system. For example, the aromatic hydrocarbon core of the diamino-polycyclic aromatic hydrocarbon diol is selected from a list of polycyclic aromatic hydrocarbons comprising anthracene, phenanthrene, tetracene, pyrene, triphenylene, chrysene, benzo[c]phenanthrene, perylene, and pentacene, or any other polycyclic aromatic hydrocarbon known to one of skill in the art.

Example embodiments of the cardopolybenzoxazole polymer when A is present as a polycyclic aromatic hydrocarbon are shown below:

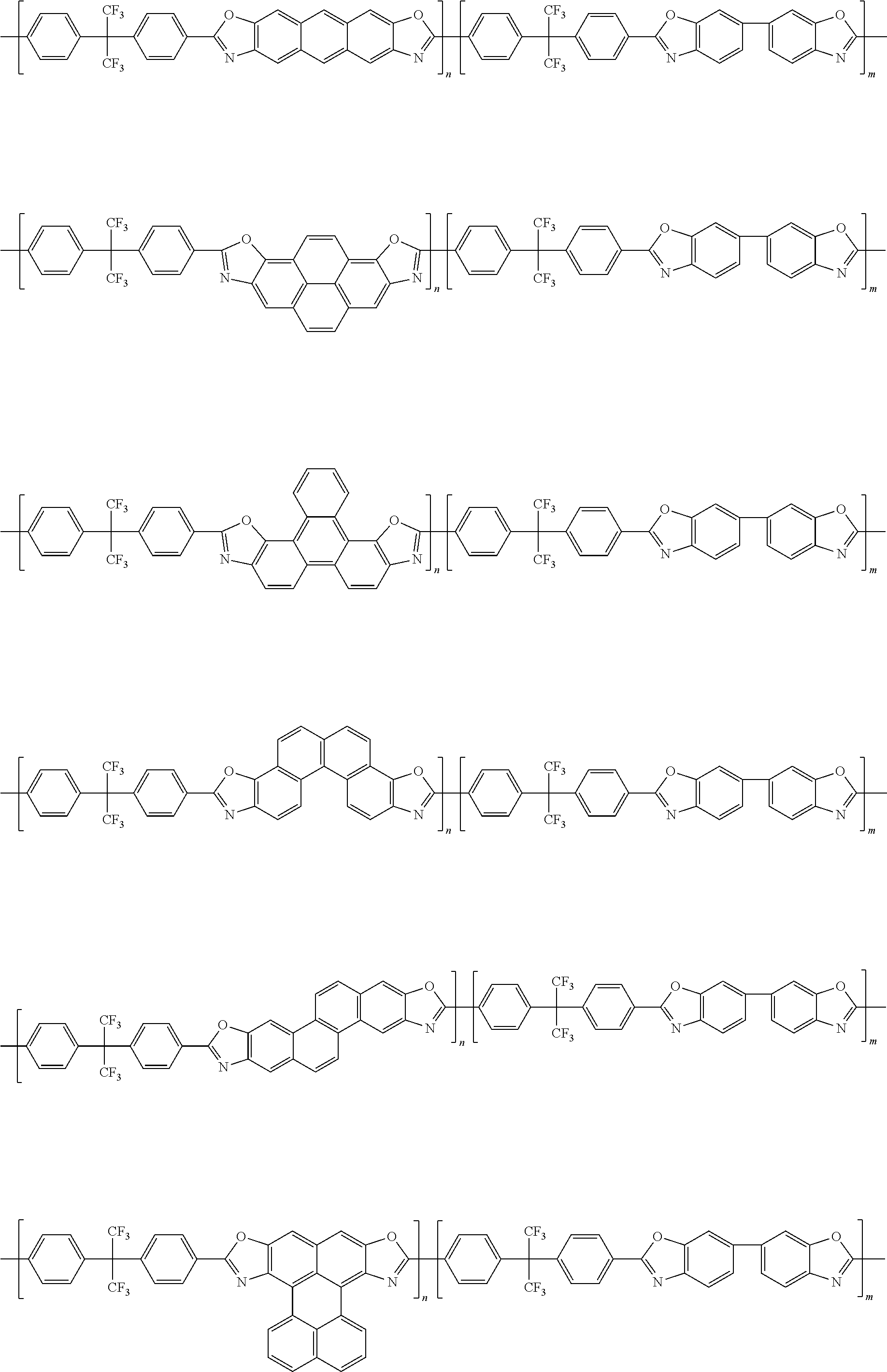

A schematic depicting the thermal rearrangement of cardo-copolyimide (CcPI) to cardopolybenzoxazole copolymer (CPBOc) in a preferred embodiment of the invention is shown in Scheme 4:

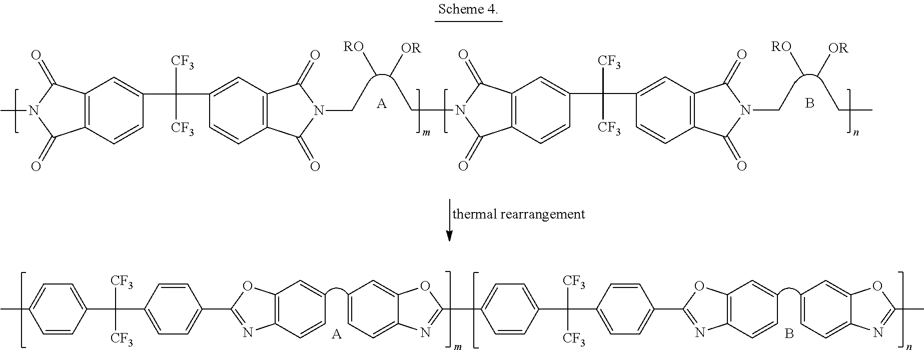

Where, for obtaining CPBOc, A is:

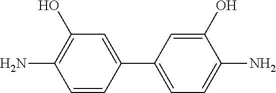 [SMILES: Nc1ccc(-c2ccc(N)c(O)c2)cc1O]

### And B is:

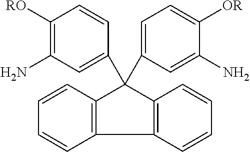

Substituent R is H or —C(CH₃)O depending upon the method of imidization; and m and n are each integers ranging from 0 to 100, wherein the sum of m and n is 100.

In one embodiment of the invention, m and n are integers from 5 to 95, wherein the sum of m and n is 100, and in a preferred embodiment of the invention, m and n are integers from 10 to 90, wherein the sum of m and n is 100.

The cardo-polybenzoxazole copolymers of the invention are random copolymers.

### Use of PBO, CPBO, and CPBOc Membranes

The cardopolybenzoxazole copolymers of the invention are suitable for the separation of fluids in a variety of processes, including, but not limited to, the separation of mixtures of gases, liquids, vapors, aqueous solutions, hydrocarbon isomers, olefins/paraffins, iso/normal paraffins, proteins, as well as recovery and purification of biofuel from acetone-butanol-ethanol (ABE) fermentation (e.g. pervaporation), adsorption, deep sulfurization of gasoline and diesel fuel, desalination of water, and forward osmosis processes.

One example separation process that is particularly suitable for use with the invention is the separation of at least one gas from a mixture of gases. This invention is even more particularly suitable for use in the separation of gaseous mixtures comprising CO₂/N₂, CO₂/CH₄, O₂/N₂, and H₂/CH₄. The detailed experimental procedure and equipment design for pure gas permeation measurement is reported elsewhere [17]. The pure gas permeability is measured by using a constant volume method. Gas permeation experiments may employ a diffusion cell, which is separated into two compartments by a membrane of the present invention. The upstream feed pressure and testing temperature are maintained at a constant level, and the increase in downstream pressure is measured once the system reaches a steady state. From this measurement, the permeability and selectivity values are obtained.

The cardo-polybenzoxazole copolymer membrane materials of the invention are particularly advantageous in their application to separation technologies. As compared to known examples of polybenzoxazole membranes, the materials of the present invention exhibit superior performance in gas permeability and separation processes, surpassing Robeson's upper bound trade-off curves [6].

### DEFINITIONS

“Alkyl” means a saturated aliphatic branched or straight-chain hydrocarbon radical having the specified number of carbon atoms that can be substituted or unsubstituted. Thus, “(C₁-C₆) alkyl” means a radical having from 1-6 carbon atoms in a linear or branched arrangement. “(C₁-C₆)alkyl” includes methyl, ethyl, propyl, butyl, pentyl and hexyl.

“Substituted alkyl” includes alkyl groups, as defined above, in which one or more hydrogens is replaced by an alkoxy, amino, hydroxyl, or thiol group.

“Haloalkyl” includes mono, poly, and perhaloalkyl groups, where “alkyl” is defined above, and where each halogen is independently selected from fluorine, chlorine, and bromine.

The term “(C₆-C₂₄)aryl” means carbocyclic aromatic rings. The term “carbocyclic aromatic group” may be used interchangeably with the terms “aryl,” “aryl ring,” “carbocyclic aromatic ring,” “aryl group,” and “carbocyclic aromatic group.” A “substituted aryl group” is substituted at any one or more substitutable ring atom. In one embodiment, R³ and R⁴ can be a monocyclic, bicyclic, or tricyclic carbocyclic ring system containing from 6 to 24 carbon atoms that can include phenyl (Ph), naphthyl, anthracenyl, 1,2-dihydronaphthyl, 1,2,3,4-tetrahydronaphthyl, indanyl, indenyl, and in a preferred embodiment, R³ and R⁴ are taken together to be fluorenyl.

The term “independently” means that the substituents may be identical or different.

The term “cardo group” means a sterically large polycyclic aromatic group. In a preferred embodiment, the cardo group is fluorenyl, anthracenyl, napthyl, phenalenyl, acenaphthenyl, benzo[a]fluorenyl, and in a more preferred embodiment, the cardo group is fluorenyl.

### EXAMPLES

The following examples are provided to illustrate one or more preferred embodiments of the invention, but are not limited embodiments thereof. Numerous variations can be made to the following examples that lie within the scope of the invention.

### Example 1

### Synthesis of Polyimide (PI) from 4,4′-hexafluoroisopropylidenediphthalic anhydride (6FDA) and 3,3′-dihydroxybenzidine (HAB)

Polyimide (PI) was synthesized using 4,4′-hexafluoroisopropylidenediphthalic anhydride (6FDA) and 3,3′-dihydroxybenzidine (HAB): 5 mmol HAB was dissolved in 13.2 g NMP in a 50 mL conical flask equipped with nitrogen or argon inlet. After stirring under nitrogen or argon atmosphere for 1 h, 5 mmol 6FDA was added into the solution and continuously stirred at least 3 h in an ice bath. The intermediate poly(amic acid) was then chemically imidized to polyimide using acetic anhydride as catalyst and pyridine as weak base. 21.2 mmol acetic anhydride and 25.8 mmol pyridine were added into the poly(amic acid) and the solution was stirred at room temperature at least 12 h. The resulted polyimide solution was precipitated into 1000 mL methanol under stirring. After washing with methanol three times, the polymer was dried in a vacuum oven at 60° C. overnight, and stored in a desiccator before use.

### Example 2

### Preparation of Polyimide (PI) Membrane

The PI (6FDA-HAB) membrane was prepared as follows: 0.5 g of the polymer synthesized in Example 1 was dissolved in 9.5 g N,N-dimethylformamide (DMF) under stirring for 2 h to obtain a homogeneous casting solution. The homogeneous solution was casted onto a petri dish and dried in an oven at 80° C. overnight to evaporate the latent solvent. The pristine membranes were then detached from the petri dish and placed into a vacuum oven for complete solvent evaporation by heating from 75° C. to 200° C. with a temperature ramping rate of 25° C./h.

### Example 3

### Preparation of Polybenzoxazole Polymer Membrane (PBO) from PI (6FDA-HAB) at 425° C.

The polybenzoxazole polymer membrane, PBO (6FDA-HAB), was prepared by thermally treating the PI (6FDA-HAB) membrane prepared in Example 2 in a preheated furnace at 425° C. under vacuum for 30 minutes.

### Example 4

### Synthesis of Cardo-Containing Polyimide (CPI) from 4,4′-hexafluoroisopropyl-idenediphthalic anhydride (6FDA) and 9,9-bis(3-amino-4-hydroxyphenyl)fluorene (BisAHPF)

Cardo-containing polyimide (CPI) was synthesized using 4,4′-hexafluoroisopropylidenediphthalic anhydride (6FDA) and 9,9-bis(3-amino-4-hydroxyphenyl)fluorene (BisAHPF). 5 mmol BisAHPF was dissolved in 16.5 g NMP in a 50 mL conical flask equipped with a nitrogen or argon inlet. After stirring under nitrogen or argon atmosphere for 1 h, 5 mmol 6FDA was added into the solution and continuously stirred at least 3 h in an ice bath. The intermediate cardo-containing poly(amic acid) was then chemically imidized to cardo-containing polyimide using acetic anhydride as catalyst and pyridine as weak base. 21.2 mmol acetic anhydride and 25.8 mmol of pyridine were added into the cardo-containing poly(amic acid) and the solution was stirred at room temperature at least 12 h. The resulted cardo-containing polyimide solution was precipitated into 1000 mL methanol under stirring. After washing with methanol three times, the polymer was dried in a vacuum oven at 60° C. overnight, and stored in a desiccator before use.

### Example 5

### Preparation of Cardo-Containing Polyimide (CPI) Membrane

The CPI (6FDA-BisAHPF) membrane was prepared as follows: 0.5 g of the polymer synthesized in Example 4 was dissolved in 9.5 g DMF under stirring for 2 h to obtain a homogeneous casting solution. The homogeneous solution was casted onto a petri dish and dried in an oven 80° C. overnight to evaporate the latent solvent. The pristine membranes were then detached from the petri dish and placed into the vacuum oven for complete solvent evaporation by heating from 75° C. to 200° C. with a temperature ramping rate of 25° C./h.

### Example 6

### Preparation of Cardo-polybenzoxazole Polymer Membrane (CPBO) from CPI (6FDA-BisAHPF) at 425° C.

The cardo-polybenzoxazole polymer membrane, CPBO (6FDA-BisAHPF), was prepared by thermally treating the CPI (6FDA-BisAHPF) membrane prepared in Example 5 in a preheated furnace at 425° C. under vacuum for 30 minutes.

### Example 7

### Synthesis of Cardo-Containing Copolyimide (CcPI) from (6FDA), (HAB) and (BisAHPF) by Varying Molar Ratio of Diamine (HAB) and Cardo-diamine (BisAHPF)

Cardo-containing copolyimides (CcPI) were synthesized using 4,4′-hexafluoroisopropylidenediphthalic anhydride (6FDA), 3,3′-dihydroxybenzidine (HAB), and 9,9-bis(3-amino-4-hydroxyphenyl)fluorene (BisAHPF). The molar ratios of diamine and cardo-diamine, HAB:BisAHPF are 95:5, 90:10, 85:15, 80:20, 70:30, 50:50 and 30:70. For example, for the synthesis of cardo-containing copolyimide with molar ratio of HAB:BisAHPF of 95:5, 4.75 mmol HAB and 0.25 mmol BisAHPF were dissolved in 13.4 g NMP in a 50 mL conical flask equipped with nitrogen or argon inlet. After stirring under nitrogen or argon atmosphere for 1 h, 5 mmol 6FDA was added into the solution and continuously stirred at least 3 h in an ice bath. The intermediate cardo-containing poly(co-amic acid) was then chemically imidized to cardo-containing copolyimide using acetic anhydride as catalyst and pyridine as weak base. 21.2 mmol acetic anhydride and 25.8 mmol pyridine were added into the cardo-containing poly(co-amic acid) and the solution was stirred at room temperature at least 12 h. The resulting cardo-containing copolyimide solution was precipitated into 1000 mL methanol under stirring. After washing with methanol three times, the copolymer was dried in a vacuum oven at 60° C. overnight, and stored in a desiccator before use.

### Example 8

### Preparation of Cardo-Containing Copolyimide (CcPI) Membrane

The CcPI (6FDA-HAB(m)-BisAHPF(n)) membranes were prepared as follows: 0.5 g of copolymer synthesized in Example 7 was dissolved in 9.5 g DMF under stirring for 2 h to obtain a homogeneous casting solution. The homogeneous solution was casted onto a petri dish and dried in an oven at temperature of 80° C. overnight to evaporate the latent solvent. The pristine copolymer membranes were then detached from the petri dish and placed into the vacuum oven for complete solvent evaporation by heating from 75° C. to 200° C. with a temperature ramping rate of 25° C./h. m and n represent the molar ratio of HAB and BisAHPF as follows: m=95, n=5; m=90, n=10; m=85, n=15; m=80, n=20; m=70, n=30; m=50, n=50 and m=30, n=70.

### Example 9

### Preparation of Cardo-polybenzoxazole Copolymer Membrane (CPBOc) from CcPI (6FDA-HAB(m)-BisAHPF(n)) Membrane at 425° C.

The cardo-polybenzoxazole copolymer membranes, CPBOc (6FDA-HAB(m)-BisAHPF(n)), were prepared by thermally treating the CcPI (6FDA-HAB(m)-BisAHPF(n)) membranes prepared in Example 8 in a preheated furnace at 425° C. under vacuum for 30 minutes. m and n represent the molar ratio of HAB and BisAHPF as follows: m=95, n=5; m=90, n=10; m=85, n=15; m=80, n=20; m=70, n=30; m=50, n=50 and m=30, n=70.

### Example 10

### Attenuated Total Reflectance-Fourier-Transformed Infra-Red (ATR-FTIR)

The chemical structures of the membranes before and after thermal treating were analyzed by Attenuated Total Reflectance Fourier-transformed Infrared (ATR-FTIR) in the scan range from 800 cm⁻¹ to 4000 cm⁻¹ using Perkin-Elmer FTIR Spectrometer Spectrum 2000. The thermal stability of the membranes was determined by using Perkin-Elmer TGA 7. The analysis was conducted under nitrogen gas at a flow rate of 100 ml/min and all the membranes are subjected to a heating rate of 15° C./min from room temperature to 800° C.

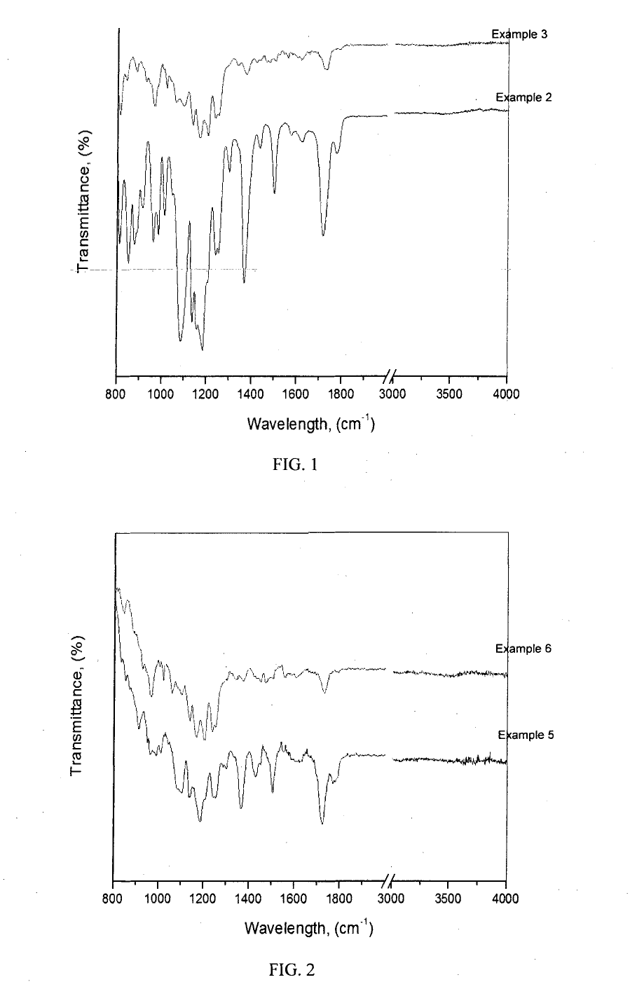

FIG. 1 shows FT-IR spectra of PI membrane obtained in Example 2 and PBO membrane obtained in Example 3. It can be seen from FIG. 1 that the characteristic IR stretch of an imide group at 1099 cm⁻¹, 1381 cm⁻¹, 1720 cm⁻¹ and 1782 cm⁻¹ were observed for polyimide (PI). For the PBO membrane of Example 3, the characteristic IR stretches of benzoxazole at 1058 cm⁻¹, 1480 cm⁻¹, 1550 cm⁻¹ and 1617 cm⁻¹ were observed, which confirmed that the PI membrane of Example 2 was converted to PBO membrane of Example 3 by thermal treatment.

The FT-IR spectra of the CPI membrane obtained in Example 5 and the CPBO membrane obtained in Example 6 are shown in FIG. 2. Cardo-containing polyimide (CPI) of Example 5 shows the characteristic IR stretch of an imide group at 1099 cm⁻¹, 1381 cm⁻¹, 1720 cm⁻¹ and 1782 cm⁻¹. The characteristic stretches at 1058 cm⁻¹, 1480 cm⁻¹, 1550 cm⁻¹ and 1617 cm⁻¹ were observed for the CPBO membrane of Example 6. These characteristic peaks confirmed that the CPI membrane of Example 5 was converted to CPBO membrane of Example 6 by thermal treatment.

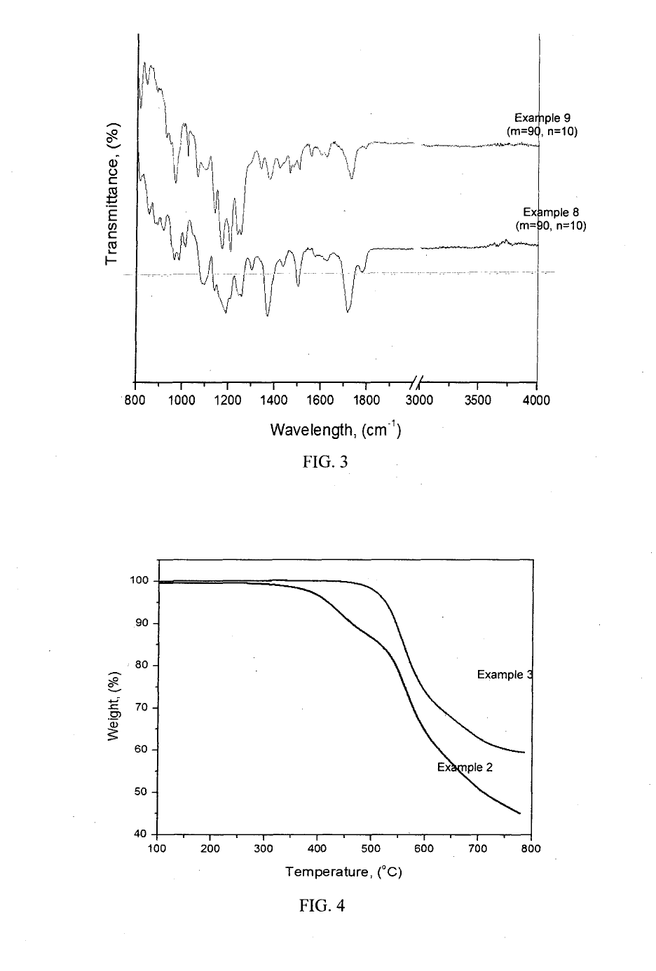

FIG. 3 shows the FT-IR spectra of CcPI membranes, 6FDA-HAB(m)-BisAHPF(n) (m=90, n=10) obtained in Example 8 and CPBOc membrane, 6FDA-HAB(m)-BisAHPF(n) (m=90, n=10) obtained in Example 9. 6FDA-HAB(90)-BisAHPF(10) of Example 9 shows the characteristic IR stretches of an imide group at 1099 cm⁻¹, 1381 cm⁻¹, 1720 cm⁻¹ and 1782 cm⁻¹. The benzoxazole peaks at 1058 cm⁻¹, 1480 cm⁻¹, 1550 cm⁻¹ and 1617 cm⁻¹ observed for 6FDA-HAB(90)-BisAHPF(10) confirmed that the 6FDA-HAB(90)-BisAHPF(10) obtained in Example 8 was converted to polybenzoxazole membrane obtained in Example 9 by thermal treatment. The CcPI (6FDA-HAB(m)-BisAHPF(n)) membranes obtained in Examples 8 (for m and n as follows: m=95, n=5; m=90, n=10; m=85, n=15; m=80, n=20; m=70, n=30; m=50, n=50; and m=30, n=70) showed similar IR spectra compared to the CcPI (6FDA-HAB(90)-BisAHPF(10)) membrane, and the CPBOc (6FDA-HAB(m)-BisAHPF(n)) membranes obtained in Example 9 (for m and n as follows: m=95, n=5; m=90, n=10; m=85, n=15; m=80, n=20; m=70, n=30; m=50, n=50 and m=30, n=70) contain the similar chemical structure compared to the CPBOc (6FDA-HAB(90)-BisAHPF(10)) membrane.

### Example 11

### Thermogravimetric Analysis (TGA)

FIG. 4 shows the TGA curves of PI of Example 2 and PBO of Example 3. It can be seen from the figure that the polyimide of Example 2 starts to thermally rearrange in the temperature range of 300 to 500° C., whereas thermal degradation of the polybenzoxazole of Example 3 is not observed within this thermal conversion temperature.

TGA curves of CPI of Example 5 and CPBO of Example 6 is shown in FIG. 5. It can be seen from the figure that the cardo-containing polyimide of Example 5 starts to thermally rearrange in the temperature range from 300 to 500° C., whereas thermal degradation of the polybenzoxazole of Example 6 is not observed within this thermal conversion temperature.

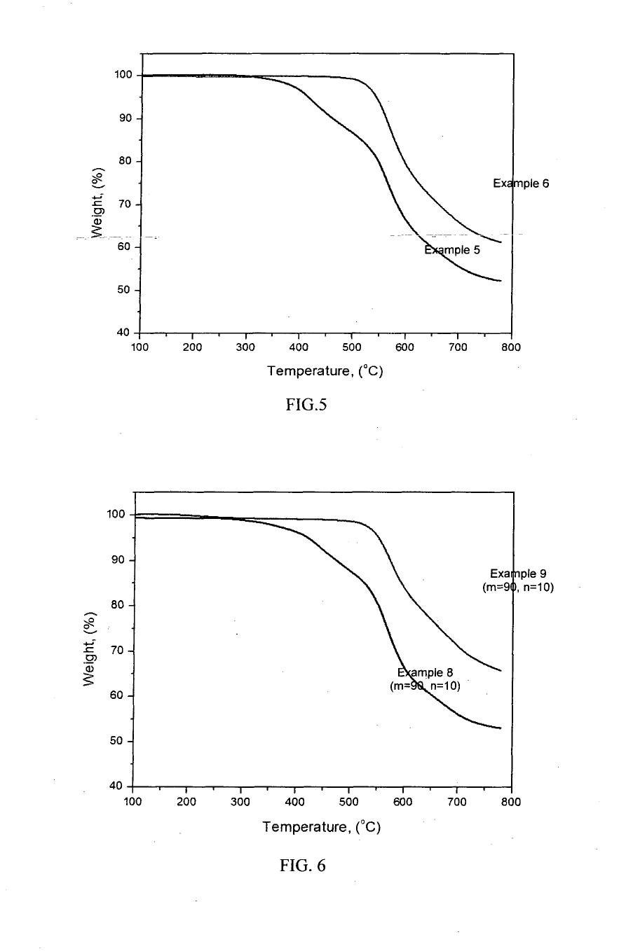

FIG. 6 shows the TGA curves of CcPI of Example 8 (m=90, n=10) and CPBOc of Example 9 (m=90, n=10). The figure shows that the cardo-containing copolyimide of Example 8 starts to thermally rearrange in the temperature range from 300 to 500° C., whereas thermal degradation of the polybenzoxazole of Example 3 is not observed within this thermal conversion temperature. The CcPI (6FDA-HAB(m)-BisAHPF(n)) membranes obtained in Examples 8 (for m and n as follows: m=95, n=5; m=90, n=10; m=85, n=15; m=80, n=20; m=70, n=30; m=50, n=50 and m=30, n=70) showed the similar thermal decomposition curves as compared to CcPI (6FDA-HAB(90)-BisAHPF(10)) and CPBOc (6FDA-HAB(m)-BisAHPF(n)) membranes obtained in Example 9 (for m and n as follows: m=95, n=5; m=90, n=10; m=85, n=15; m=80, n=20; m=70, n=30; m=50, n=50 and m=30, n=70) showed the similar thermal decomposition curves as compared to CPBOc (6FDA-HAB(90)-BisAHPF(10)).

### Example 12

### Pure Gas Permeation Results of Polybenzoxazole Polymer (PBO), Cardo-polybenzoxazole polymer (CPBO) and Cardo-polybenzoxazole Copolymer (CPBOc) Membranes

The detailed experimental procedure and equipment design for pure gas permeation measurement is reported elsewhere [17]. The pure gas permeability was measured by using a constant volume method. The feed pressure and testing temperature is maintained at 3.5 atm and 35° C., respectively. The gases were measured in the sequence of H₂, O₂, N₂, CH₄, and CO₂ and each reported value is the average of three experimental data points. After the system reached steady state, the gas permeability was determined from the rate of downstream pressure increase (dp/dt) obtained using the following equation:

$$P = \frac{273 \times {10}^{10}}{760} \frac{VL}{AT [ \frac{{p}_{2} \times 76}{14.7} ]} ( \frac{d p}{d t} ) \qquad ( 1 )$$

where P is permeability in Barrer (1 Barrer=1×10⁻¹⁰ cm³ (STP)-cm/cm² sec cmHg), D represent average effective diffusivity (cm²/s) and S is apparent sorption coefficient/solubility (cm³ (STP)/cm³ polymer cm Hg). V is volume of the downstream chamber (cm³), L is film thickness (cm), A represents effective area of the membrane (cm²), T is experimental temperature (K) and p₂ represents pressure of the feed gas in the upstream chamber (psia).
The ideal selectivity of a membrane for gas A to gas B is as follows:

$${α}_{A \text{/} B} = \frac{{P}_{A}}{{P}_{B}} \qquad ( 2 )$$

The permeabilities of polybenzoxazole polymer (PBO), cardo-polybenzoxazole polymer (CPBO) and cardo-polybenzoxazole copolymer (CPBOc) membranes prepared in Examples 3, 6 and 9 were examined for pure gases H₂, O₂, N₂, CH₄, and CO₂ at 35° C. and an upstream pressure of 3.5 atm. It can be seen from Table 1 that all molar ratios of the cardo-polybenzoxazole copolymer (CPBOc) membranes demonstrate significantly higher permeability as compared to polybenzoxazole (PBO) and cardo-polybenzoxazole (CPBO) polymer membranes. The CPBOc of 6FDA-HAB(90)-BisAHPF(10) shows the highest permeability for all gases, with moderate O₂/N₂, H₂/CH₄, and CO₂/CH₄ selectivities.

TABLE 1
Pure gas permeation results of polybenzoxazole (PBO), cardo-
polybenzoxazole (CPBO) and cardo-polybenzoxazole copolymer (CPBOc)
membranes

| | Permeability, Barrer | | | | | Ideal selectivity | | |
|---|---|---|---|---|---|---|---|---|
| Membrane | H₂ | O₂ | N₂ | CH₄ | CO₂ | O₂/N₂ | H₂/CH₄ | CO₂/CH₄ |
| 6FDA-HAB | 407 | 62.7 | 14.3 | 9.2 | 296 | 4.4 | 44.1 | 32.1 |
| 6FDA-HAB(95)- | 1189 | 227 | 57.1 | 41.7 | 1079 | 4.0 | 28.5 | 25.9 |
| BisAHPF(5) | | | | | | | | |
| 6FDA-HAB(90)- | 1479 | 316 | 83.6 | 65.0 | 1539 | 3.8 | 22.8 | 23.7 |
| BisAHPF(10) | | | | | | | | |
| 6FDA-HAB(85)- | 1254 | 264 | 69.3 | 58.7 | 1306 | 3.8 | 21.4 | 22.2 |
| BisAHPF(15) | | | | | | | | |
| 6FDA-HAB(80)- | 1228 | 269 | 68.9 | 58.4 | 1267 | 3.9 | 21.0 | 21.7 |
| BisAHPF(20) | | | | | | | | |
| 6FDA-HAB(70)- | 1191 | 255 | 68.2 | 60.5 | 1238 | 3.7 | 19.7 | 20.5 |
| BisAHPF(30) | | | | | | | | |
| 6FDA-HAB(50)- | 945 | 191 | 49.2 | 44.1 | 935 | 3.9 | 21.4 | 21.2 |
| BisAHPF(50) | | | | | | | | |
| 6FDA-HAB(30)- | 723 | 133 | 32.4 | 28.0 | 639 | 4.1 | 25.8 | 22.8 |
| BisAHPF(70) | | | | | | | | |
| 6FDA-BisAHPF | 371 | 54.2 | 11.8 | 9.2 | 255 | 4.6 | 40.2 | 27.7 |

*All permeation results were tested at 35° C. and 3.5 atm

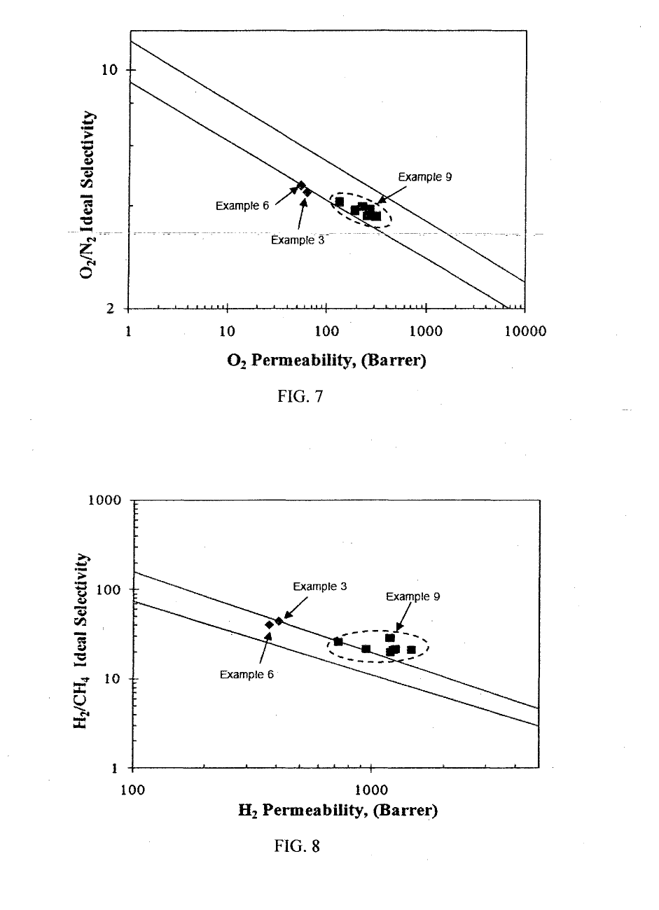

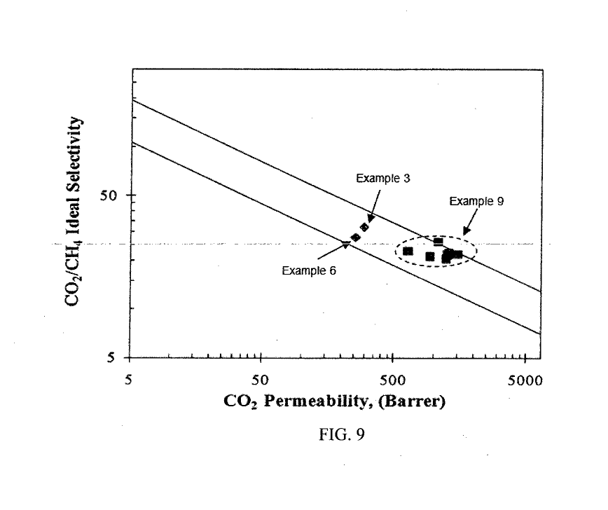

FIGS. 7 to 9 are the graphs comparing oxygen permeability (Barrer) and oxygen/nitrogen selectivity, hydrogen permeability (Barrer) and hydrogen/methane selectivity and carbon dioxide permeability (Barrer) and carbon dioxide/methane selectivity for all membranes prepared in Examples 3, 6 and 9. In these three graphs, the materials of the present invention showed superior gas permeabilities with moderate selectivities, surpassing Robeson's upper bound trade-off curves [6].

### REFERENCES

1. H. B. Park, et al., Polymers with cavities tuned for fast selective transport of small molecules and ions, Science, 318 (2007) 254-258.
2. B. T. Low, et al., Tuning the free volume cavities of polyimide membranes via the construction of pseudo-interpenetrating networks for enhanced gas separation performance, Macromolecules, 42 (2009) 7042-7054.
3. R. Baker, Future directions of membrane gas-separation technology, Membr. Technol., 2001 (2001) 5-10.
4. B. T. Low, et al., Amplifying the molecular sieving capability of polyimide membranes via coupling of diamine networking and molecular architecture, Polymer, 50 (2009), 3250-3258.
5. Y. Xiao, T. S. Chung, Grafting thermally labile molecules on cross-linkable polyimide to design membrane materials for natural gas purification and CO₂ capture, Energy Environ. Sci., 4 (2011), 201-208.
6. L. M. Robeson, Correlation of separation factor versus permeability for polymeric membranes, J. Membr. Sci. 62 (1991) 165.
7. M. K. Ghosh, K. L. Mittal, Polyimides: Fundamentals and applications; CRC Press: Boca Raton, Fla., 1996.
8. D. R. Paul, Y. P. Yampolskii, Polymeric gas separation membranes; CRC Press: Boca Raton, Fla., 1993.
9. S. H. Han, et al., Thermally Rearranged (TR) polybenzoxazole: Effects of diverse imidization routes on physical properties and gas transport behaviors, Macromolecules 43 (2010) 7657-7667.
10. C. H. Jung, et al., Highly permeable and selective poly(benzoxazole-co-imide) membranes for gas separation, J. Membr. Sci, 350 (2010) 301-309.
11. J. L. Choi, et al., Thermally Rearranged (TR) poly(benzoxazole-co-pyrrolone) membranes tuned for high gas permeability and selectivity, J. Membr. Sci. 349 (2010) 358-368.
12. G. L. Tullos, et al., Thermal conversion of hydroxy-containing imides to benzoxazoles: polymer and model compound study, Macromolecules 32 (1999) 3598-3612.
13. S. Kazama, L. Teramoto, K. Haraya, Carbon dioxide and nitrogen transport properties of bis(phenyl)fluoren-based cardo-polymer membranes, J. Membr. Sci 207 (2002) 91-104.
14. B. Dasgupta, S. Banerjee, A study of gas transport properties of semifluorinated poly(ether imide) membranes containing cardo diphenylfluorene moieties, J. Membr. Sci. 362 (2010) 58-67.
15. Y. Hirayama, et al., Novel membranes for carbon dioxide separation, Energy Convers. Mgmt. 36 (1995) 435-438.
16. D. F. Li, et at, J. Membr. Sci. 198 (2002) 211.
17. W. H. Lin, et al., Gas transport properties of 6FDA-Durene/1,4-phenylenediamine (pPDA) copolyimides, J. Polym. Sci.: Part B: Polym. Phys., 38 (2000) 2703-2713.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A cardo-polybenzoxazole copolymer having the structure of formula (I): 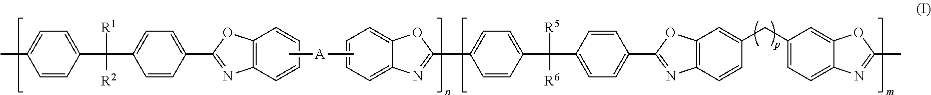
wherein: m is an integer from 0 to 100;
n is an integer from 0 to 100;
and the sum of m and n is 100;
p is an integer from 0 to 1;
R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group; and
R⁵ and R⁶ are independently (C₁-C₆)alkyl or (C₁-C₆)haloalkyl.

2. The copolymer of claim 1, wherein when A is of the formula CR³R⁴, R³ and R⁴ are taken together to form a ring structure of formula (II): 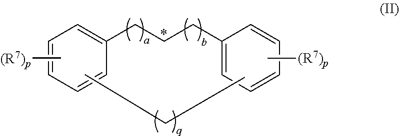
Wherein: a and b are each integers independently selected from zero to 5 and the sum of a and b is less than or equal to 10;
q is an integer from zero to 1;
each R⁷ is independently selected from H, (C₁-C₆)alkyl, (C₆-C₂₄)aryl, or heteroaryl;
p is an integer from 1 to 4;
and the asterisk (*) indicates the point of attachment to the carbon of CR³R⁴.

3. The copolymer of claim 1, wherein the cardo-polybenzoxazole copolymer comprises units of both cardo-polybenzoxazole and polybenzoxazole.

4. The copolymer of claim 1, wherein the cardo-polybenzoxazole copolymer comprises repeating units of formula (III): 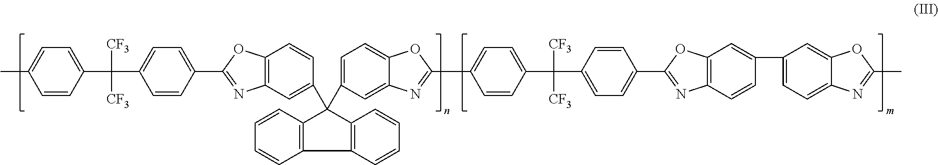
wherein: m is an integer from 0 to 100;
n is an integer from 0 to 100;
and the sum of m and n is 100.

5. The copolymer of claim 1, wherein the cardo-polybenzoxazole copolymer is in the form of a membrane having a geometry comprising flat sheet, hollow fiber, tube, thin film composite, or disk.

6. A method for making a cardo-polybenzoxazole copolymer membrane comprising:
a) reacting a diamine of formula (IV) 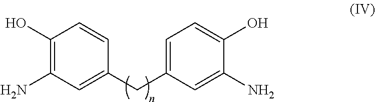
Wherein n is an integer from zero to 1;
and a cardo-diamine of formula (V) 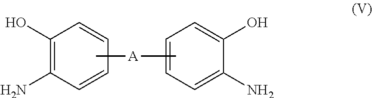
wherein: A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group;
and with a diphthalic anhydride having the formula (VI) 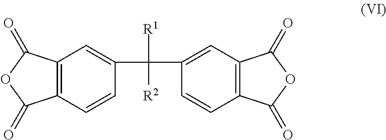
wherein R¹ and R² are independently (C₁-C₆)alkyl or (C₁-C₆)haloalkyl;
to produce a cardo-polyimide copolymer of formula (VII) 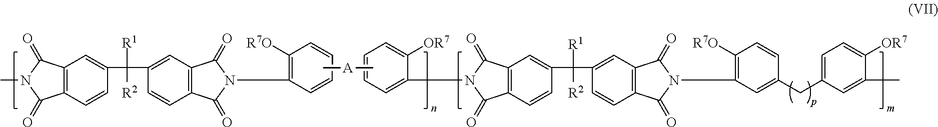
wherein: R⁷ is H or —C(CH₃)O;
R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to form a cardo group;
p is an integer from zero to 1;
m is an integer from 0 to 100;
n is an integer from 0 to 100;
and the sum of m and n is 100.
b) preparing a mixture of the cardo-polyimide copolymer in solvent, and casting the mixture into a membrane;
c) exposing the membrane of step (b) to temperature conditions to produce a thermal rearrangement of the cardo-polyimide copolymer membrane to the cardo-polybenzoxazole copolymer membrane.

7. The method of claim 6, wherein the cardo-polyimide copolymer comprises units of both cardo-polyimide and polyimide.

8. The method of claim 6, wherein step (c) is performed at a temperature of from about 400° C. to about 450° C.

9. The method of claim 6, wherein the cardo-polybenzoxazole copolymer membrane comprises repeating units of formula (III): 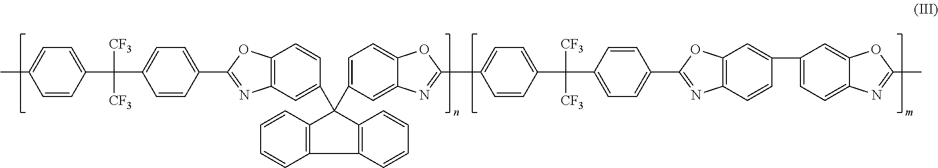
wherein: m is an integer from 0 to 100;
n is an integer from 0 to 100;
and the sum of m and n is 100.

10. The method of claim 6, wherein the cardo-polyimide copolymer membrane comprises repeating units of formula (VIII): 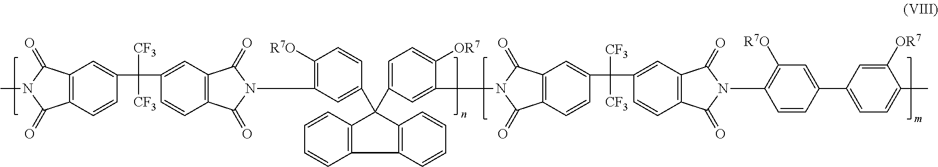
wherein: R⁷ is H or —C(CH₃)O;
wherein: m is an integer from 0 to 100;
n is an integer from 0 to 100;
and the sum of m and n is 100.

11. The method of claim 6, wherein the cardo-polyimide copolymer of formula (VIII) is obtained by imidization of cardo-poly(co-amic acid) comprising repeating units of formula (IX). 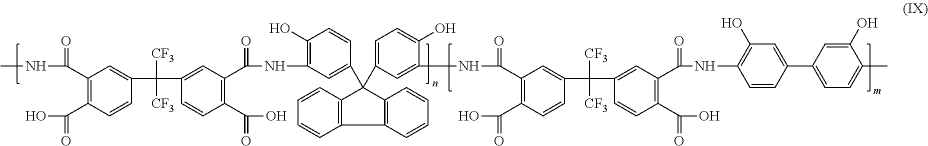
wherein: m is an integer from 0 to 100;
n is an integer from 0 to 100;
and the sum of m and n is 100.

12. The method of claim 6, wherein the cardo-polybenzoxazole copolymer is cast into a membrane having a geometry comprising flat sheet, hollow fiber, tube, thin film composite, or disk.

13. A method for separating at least one fluid from a mixture of fluids, comprising:
a) providing the cardo-polybenzoxazole copolymer membrane of formula (I) 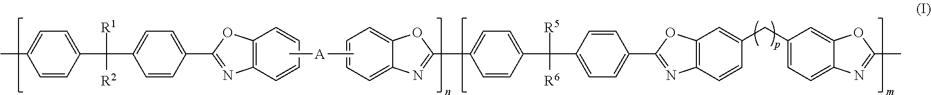
wherein: m is an integer from 0 to 100;
n is an integer from 0 to 100;
and the sum of m and n is 100;
p is an integer from zero to 1;
R¹ and R² are independently (C₁-C₆)alkyl or (C₁-C₆)haloalkyl;
A is either a methylene linker of the formula CR³R⁴ or a polycyclic aromatic hydrocarbon such that when A is not present, there is a fused ring system, and when A is present, there is a multi-ring system;
R³ and R⁴ are independently (C₁-C₆)alkyl or (C₆-C₂₄)aryl, or R³ and R⁴ can be taken together to comprise a cardo group; and
R⁵ and R⁶ are independently (C₁-C₆)alkyl or (C₁-C₆)haloalkyl;
b) bringing a mixture of fluids under pressure into contact with the membrane of step (a), whereby one of the at least one fluids permeates the membrane preferentially with respect to at least one of the other fluids in the mixture of fluids; thereby separating the fluid from the mixture.

14. The method of claim 13, wherein the copolymer comprises cardo-polybenzoxazole, cardo-polybenzothiazole, cardo-polypyrrolone, cardo-polybenzimidazole, polymer and co-polymers, or the precursor materials used to prepare the thermally rearranged materials.

15. The method of claim 13, wherein the at least one fluid from a mixture of fluids is at least one gas from a mixture of gases.
